(19) United States
(12) Patent Application Publication
(10) Pub. No.: US 2025/0260681 A1
(43) Pub. Date: Aug. 14, 2025

(54) PERSONALIZED FEDERATED LEARNING METHOD, USER AUTHENTICATION METHOD, AND DEVICE PERFORMING THE SAME

(71) Applicant: KAKAOBANK CORP., Seongnam-si (KR)

(72) Inventors: Han Sol Kim, Seongnam-si (KR); Young Jun Kwak, Seongnam-si (KR)

(21) Appl. No.: 19/047,870

(22) Filed: Feb. 7, 2025

(30) Foreign Application Priority Data
Feb. 14, 2024 (KR) 10-2024-0020869

(51) Int. Cl. H04L 9/40; G06F 3/041; G06V 10/26; G06V 10/82

(52) U.S. Cl. CPC H04L 63/08; G06F 3/041; G06V 10/26; G06V 10/82

(57) ABSTRACT

A personalized federated learning method performed by a processor of a user terminal operating in conjunction with a server, the method comprising: generating input data based on user data received through an interface of the user terminal; inputting the input data into a first learning model provided in the user terminal and training the first learning model using the corresponding output; transmitting local parameters for weights of a neural network included in the first learning model to the server; receiving global parameters derived based on the local parameters from the server; and inputting the input data into the first learning model, to which the global parameters are applied, and a second learning model associated with the first learning model, and training the second learning model using the corresponding output.

### CROSS-REFERENCE TO RELATED APPLICATION

This application claims priority under 35 U.S.C. § 119 to Korean Patent Application No. 10-2024-0020869 filed on Feb. 14, 2024, in the Korean Intellectual Property Office, the entire contents of which are hereby incorporated by reference.

### TECHNICAL FIELD

The present disclosure relates to a personalized federated learning method, a user authentication method using the same, and a device performing the aforementioned methods. Specifically, the present disclosure pertains to a method of training a learning model of a user terminal through personalized federated learning and performing user authentication by detecting anomalies in user data generated in the user terminal using a pre-trained learning model.

### BACKGROUND

The matters described in this section merely provide background information pertaining to embodiments of the present disclosure and do not constitute prior art.

As financial institutions or electronic financial companies provide financial products and services through computing devices, non-face-to-face financial transactions, in which users process financial services online without directly interacting with employees of financial institutions or electronic financial businesses, have been increasing. With the rise in non-face-to-face financial transactions, the importance of technology for accurately identifying whether user information has been forged or tampered with online is growing.

As online financial transactions increase, identity verification procedures are often conducted online, leading to frequent instances of impersonation during the process. Accordingly, there is a growing need for technologies that may accurately identify in real-time whether user information has been forged or tampered with while providing financial services.

Meanwhile, with the recent utilization of AI and machine learning technologies, technologies capable of determining in real-time whether user information has been forged or tampered with are being developed. Specifically, such technologies involve training a machine learning model with normal patterns and determining that data associated with a user has been forged or tampered with when a new pattern deviating from the normal patterns is detected.

Conventionally, such machine learning has often been conducted using a centralized learning method. In many cases, the learning process of models requiring significant resources involved sending local data generated at each user terminal to a server, where the learning model was trained. This approach had a drawback of weakening the security of users' personal information during the process. Therefore, federated learning, which trains learning models in a manner that ensures local data generated at user terminals is not shared with a server while still achieving high-accuracy user authentication, may be utilized as an alternative.

However, in the case of federated learning, the use of local data with different distributions for each customer introduces a problem of data heterogeneity. Additionally, during the process of deriving global parameters commonly shared among multiple customers, there may be a loss of certain local data.

### SUMMARY

An object of the present disclosure is to provide a personalized federated learning method that improves the accuracy of user authentication by transmitting local parameters of a first learning model trained using local data at each user terminal to a server, generating global parameters at the server based on the received local parameters, distributing the global parameters to each user terminal to apply them to the first learning model, and training personalized parameters included in a second learning model of each user terminal.

Another object of the present disclosure is to provide a personalized federated learning method capable of reducing data heterogeneity by separating the timing for updating the global parameters of the first learning model from the timing for updating the personalized parameters of the second learning model.

Another object of the present disclosure is to provide a user authentication method that enhances the accuracy of user authentication by training a second learning model at the user terminal using the first learning model updated with global parameters derived during the federated learning process, and by determining anomalies in new user inputs using the pre-trained first and second learning models.

Another object of the present disclosure is to provide a personalized federated leaming method that strengthens user privacy protection by ensuring that data related to personal information generated at a user terminal is not shared with other user terminals or servers.

The objects of the present disclosure are not limited to those mentioned above, and other objects and advantages of the present disclosure that are not explicitly mentioned will become apparent from the following description and will be more clearly understood through embodiments of the present disclosure. Furthermore, it will be readily apparent that the objects and advantages of the present disclosure may be realized through the means and combinations thereof described in the claims.

According to some aspects of the disclosure, a personalized federated learning method performed by a processor of a user terminal operating in conjunction with a server, the method comprises: generating input data based on user data received through an interface of the user terminal, inputting the input data into a first learning model provided in the user terminal and training the first learning model using the corresponding output; transmitting local parameters for weights of a neural network included in the first learning model to the server, receiving global parameters derived based on the local parameters from the server; and inputting the input data into the first learning model, to which the global parameters are applied, and a second learning model associated with the first learning model, and training the second learning model using the corresponding output.

According to some aspects, the user data includes an image captured by a camera provided in the user terminal or users touch pattern information input on a touch display provided in the user terminal.

According to some aspects, the generating the input data comprises: when the user data is an image captured by the camera provided in the user terminal, dividing the image into a plurality of patches; and converting the plurality of divided patches into linear data through embedding based on positional information of the image.

According to some aspects, the generating the input data comprises: when the user data is touch pattern information input on the touch display provided in the user terminal, deriving positional information and time information corresponding to a plurality of touch inputs included in the touch pattern information; and mapping the positional information and the time information for specific touch inputs and generating sequential data arranged in the order in which the touch inputs are applied.

According to some aspects, the training the first learning model comprises: inputting the input data and receiving first output data as an output; deriving a first loss value of the first output data; and updating the neural network of the first learning model such that the first loss value is minimized.

According to some aspects, the global parameter is calculated by the server based on a plurality of local parameters for each of the first learning models provided in different user terminals.

According to some aspects, the second learning model performs: (a) applying the input data to a first personalized parameter and a second personalized parameter, respectively, to derive a first intermediate value and a second intermediate value; (b) applying the input data to the first learning model with the global parameter applied to derive a third intermediate value; (c) performing matrix multiplication on the first intermediate value and the second intermediate value to derive a fourth intermediate value; (d) applying the third intermediate value to a third personalized parameter to derive global information data; and (e) performing matrix multiplication on the personalized alignment score, which is the normalized fourth intermediate value, and the global information data to output second output data.

According to some aspects, the training the second learning model comprises: inputting the input data and receiving the second output data generated as the output of the second learning model; deriving a second loss value of the second output data; and updating the first to third personalized parameters such that the second loss value is minimized.

According to some aspects, wherein step (a) comprises: receiving an image as the input data and dividing the image into a plurality of patches; converting the plurality of divided patches into linear data through embedding based on positional information of the image; and multiplying the linear data by the first personalized parameter and the second personalized parameter in a matrix structure, respectively, to derive the first intermediate value and the second intermediate value.

According to some aspects, the first to third personalized parameters are configured in a matrix form, and the second output data is configured in a vector form.

According to some aspects, the training the first learning model and the training the second learning model are sequentially and repeatedly performed.

According to some aspects of the disclosure, a user authentication method performed by a processor of a user terminal operating in conjunction with a server, the method comprises: receiving a request for a specific service from a user through the interface of the user terminal, generating input data based on user data received through the interface, inputting the input data into the first learning model and the second learning model, which have been pre-trained by the method of claim 1, and transmitting a user authentication result determined based on the similarity between the output data of the second learning model and pre-registered user data stored in the server to the server, and providing the service requested by the user on the screen of the user terminal if the user authentication result is determined to be successful.

According to some aspects of the disclosure, a user authentication method performed by a processor of a user terminal operating in conjunction with a server, the method comprises: receiving a request for a specific service from a user through the interface of the user terminal, generating input data based on user data received through the interface, inputting the input data into the first learning model and the second learning model, which have been pre-trained by the method of claim 1, and transmitting output data of the second learning model to the server, receiving a user authentication result from the server, determined based on the similarity between the output data and pre-registered user data stored in the server; and providing the service requested by the user on the screen of the user terminal if the user authentication result is determined to be successful.

According to some aspects, sequentially training the first learning model and the second learning model based on the input data, the first output data of the first learning model, and the second output data of the second learning model, if the user authentication result is determined to be successful.

According to some aspects of the disclosure, an apparatus comprises: a processor, a memory configured to load a computer program executed by the processor, and an interface configured to exchange data with a server during the execution of the computer program, wherein the computer program comprises, generating first input data based on user input received through the interface; inputting the first input data into a first learning model included in the user terminal and training the first learning model using the corresponding output; transmitting local parameters for weights of the neural network of the first learning model to the server; receiving global parameters derived based on the local parameters from the server; and inputting the first input data into the first learning model, to which the global parameters are applied, and a second learning model associated with the first learning model, and training the second learning model using the corresponding output.

According to some aspects, the computer program further comprises: receiving a request for a specific service from a user through the interface; generating second input data based on newly received user data through the interface; inputting the second input data into the first learning model and the second learning model, and transmitting the output data of the second learning model to the server, receiving a user authentication result from the server, determined based on the similarity between the output data and pre-registered user data stored in the server; and providing the service requested by the user on the screen of the user terminal if the user authentication result is determined to be successful.

According to some aspects, a computer-readable recording medium storing a program capable of executing the method according to any one of claims 1 to 13.

The personalized federated learning method of the present disclosure may improve the accuracy of user authentication by applying global parameters derived through federated learning using a plurality of user terminals to a first learning model, training personalized parameters of a second learning model associated with the first learning model, and performing user authentication using the pre-trained first and second learning models.

In addition, the personalized federated learning method of the present disclosure may minimize performance degradation caused by data heterogeneity and loss of local data when using multiple local datasets by separating the timing for updating global parameters of the first learning model and the timing for updating personalized parameters of the second learning model. Furthermore, by distinguishing the first learning model to which global parameters are applied from the second learning model to which personalized parameters are applied and setting different update timings, the present disclosure may prevent performance degradation caused by differences in the distribution of local data.

Moreover, the user authentication method of the present disclosure may enhance the performance of the federated learning module without sharing local data related to personal information generated at a user terminal with other user terminals or servers. Accordingly, the present disclosure offers the advantage of strengthening privacy protection for users while also improving the accuracy of user authentication.

Additionally, the user authentication method of the present disclosure trains a second learning model locally at a user terminal using the first learning model updated with global parameters derived during the federated learning process. It determines anomalies in new user inputs by jointly utilizing the first learning model trained through federated learning and the second learning model trained locally. Through this approach, the present disclosure minimizes the load imposed on user terminals during the training process of the first learning model while also enhancing the accuracy of user authentication.

In addition to the above, specific effects of the present disclosure will be described in detail below in conjunction with the specific features for implementing the invention.

### BRIEF DESCRIPTION OF THE DRAWINGS

FIG. 1 is a conceptual diagram illustrating a personalized federated learning system according to several embodiments of the present disclosure.

FIG. 2 is a diagram schematically illustrating a user authentication method performed in a personalized federated learning system according to an embodiment of the present disclosure.

FIG. 3 is a block diagram illustrating the components of a user terminal according to several embodiments of the present disclosure.

FIG. 4 is a flowchart illustrating the personalized federated learning method according to several embodiments of the present disclosure.

FIG. 5 is a diagram illustrating an example of the input data generation process performed in step S100 of FIG. 4.

FIG. 6 is a diagram illustrating another example of the input data generation process performed in step S100 of FIG. 4.

FIG. 7 is a block diagram illustrating the process of training the first learning model in step S200 of FIG. 4.

FIG. 8 is a block diagram schematically illustrating the first learning model of FIG. 7.

FIG. 9 is a block diagram illustrating the process of updating global parameters through federated learning in step S300 of FIG. 4.

FIG. 10 is a block diagram illustrating the process of training the second learning model in step S400 of FIG. 4.

FIG. 11 is a flowchart specifically illustrating the personalized federated learning method according to several embodiments of the present disclosure.

FIG. 12 is a block diagram illustrating the personalized federated learning method of FIG. 11.

FIG. 13 is a flowchart illustrating a user authentication method performed in a personalized federated learning system according to another embodiment of the present disclosure.

FIG. 14 is a block diagram illustrating the user authentication method of FIG. 13.

FIG. 15 is a block diagram illustrating the operations of the server described in FIG. 14.

FIG. 16 is a diagram illustrating the hardware implementation of a device or system that performs the personalized federated learning method or the user authentication method according to some embodiments of the present disclosure.

### DETAILED DESCRIPTION OF THE PREFERRED EMBODIMENTS

The terms or words used in the disclosure and the claims should not be construed as limited to their ordinary or lexical meanings. They should be construed as the meaning and concept in line with the technical idea of the disclosure based on the principle that the inventor can define the concept of terms or words in order to describe his/her own inventive concept in the best possible way. Further, since the embodiment described herein and the configurations illustrated in the drawings are merely one embodiment in which the disclosure is realized and do not represent all the technical ideas of the disclosure, it should be understood that there may be various equivalents, variations, and applicable examples that can replace them at the time of filing this application.

Although terms such as first, second, A, B, etc. used in the description and the claims may be used to describe various components, the components should not be limited by these terms. These terms are only used to differentiate one component from another. For example, a first component may be referred to as a second component, and similarly, a second component may be referred to as a first component, without departing from the scope of the disclosure. The term ‘and/or’ includes a combination of a plurality of related listed items or any item of the plurality of related listed items.

The terms used in the description and the claims are merely used to describe particular embodiments and are not intended to limit the disclosure. Singular forms are intended to include plural forms unless the context clearly indicates otherwise. In the application, terms such as “comprise,” “comprise,” “have,” etc. should be understood as not precluding the possibility of existence or addition of features, numbers, steps, operations, components, parts, or combinations thereof described herein.

Unless otherwise defined, the phrases “A, B, or C,” “at least one of A, B, or C,” or “at least one of A, B, and C” may refer to only A, only B, only C, both A and B, both A and C, both B and C, all of A, B, and C, or any combination thereof.

Unless being defined otherwise, all terms used herein, including technical or scientific terms, have the same meaning as commonly understood by those skilled in the art to which the disclosure pertains.

Terms such as those defined in commonly used dictionaries should be construed as having a meaning consistent with the meaning in the context of the relevant art, and are not to be construed in an ideal or excessively formal sense unless explicitly defined in the application. In addition, each configuration, procedure, process, method, or the like included in each embodiment of the disclosure may be shared to the extent that they are not technically contradictory to each other.

Machine learning (ML) is a field of artificial intelligence (AI) focused on developing algorithms and techniques that enable computers to learn from data. It serves as a core technology in various fields such as data processing, image recognition, speech recognition, and internet search, demonstrating excellent performance in tasks like prediction and anomaly detection.

Among these, anomaly detection refers to identifying entities or data that exhibit patterns deviating from expectations. Machine learning-based anomaly detection models calculate the difference between actual data and predicted data and classify data as anomalous when the calculated difference exceeds a threshold value. Such anomaly detection may be utilized in “user authentication processes” to determine whether data entered by a user through a user terminal originates from the actual user.

Meanwhile, in this specification, “federated learning” refers to a training method for the first learning model performed through data exchange between a plurality of user terminals and a server, and “local learning” refers to a training method performed for specific models (e.g., the first learning model or the second learning model) within each user terminal. Details regarding federated learning and local learning will be described below.

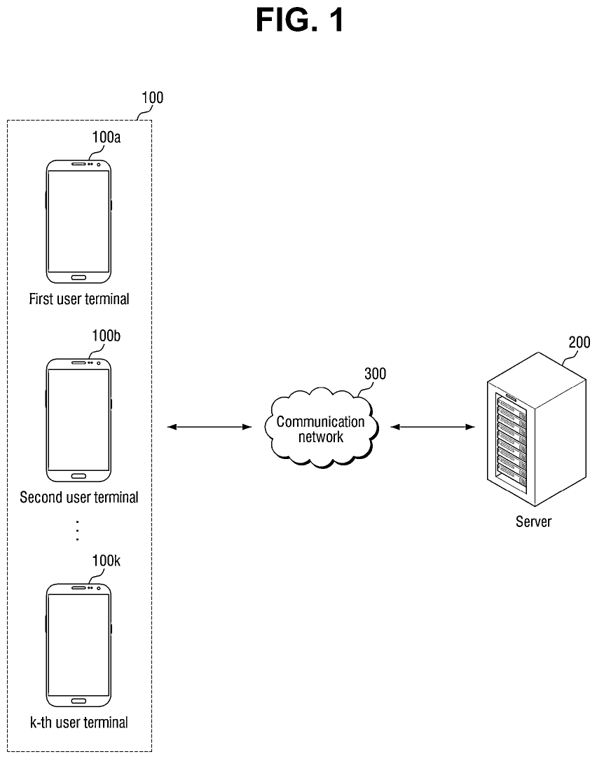

Hereinafter, with reference to FIGS. 1 to 16, a personalized federated learning method, a user authentication method, and a device performing the same according to several embodiments of the present disclosure will be described.

FIG. 1 is a conceptual diagram illustrating a personalized federated learning system according to several embodiments of the present disclosure.

Referring to FIG. 1, the personalized federated learning system according to several embodiments of the present disclosure includes a user terminal 100 and a server 200. Here, the server 200 operates in conjunction with the user terminal 100 via a communication network 300 and is capable of transmitting and receiving data with the user terminal 100. The server 200 may also operate in conjunction with a plurality of user terminals 100a to 100k and exchange data with them.

In the present disclosure, the server 200 and the user terminal 100 may be implemented as a server-client system. The server 200 may store and manage user subscription information, user authentication information, and activity information corresponding to customer accounts for each user. Additionally, the server 200 may provide various financial services to the user terminal 100 through financial applications installed on the user terminal.

Here, the financial application may be a dedicated application for providing financial services or a web browsing application. The dedicated application may either be pre-installed in the user terminal 100 or downloaded from an application distribution server and installed on the user terminal 100.

Before providing the financial services requested by the user, the server 200 may request user data necessary to provide the financial services to the user. At this time, the user data may include data required for user authentication of the customer using the user terminal 100. For example, user data necessary for user authentication may include an image captured by the user or the user's touch pattern information. However, these are merely examples, and the present disclosure is not limited thereto.

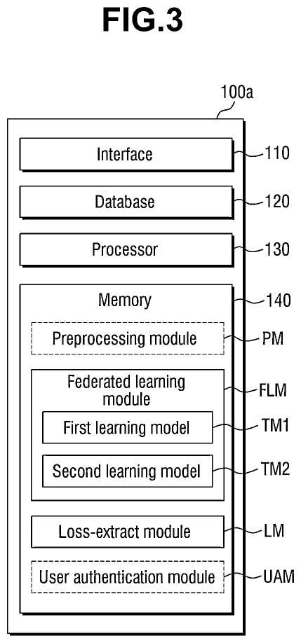

At this time, the user terminal 100 may receive user data required for authentication from the user, determine anomalies in the user data input into the user terminal 100 using a pre-trained federated learning module (e.g., FLM in FIG. 3), and perform user authentication based on the determination. Specific operational methods of the federated learning module will be described in detail below.

In the present disclosure, the user terminal 100 may operate as the subject performing the personalized federated learning method or the user authentication method according to several embodiments of the present disclosure. However, the present disclosure is not limited thereto, and each step included in the personalized federated learning method or user authentication method according to several embodiments of the present disclosure may be performed by either the server 200 or the user terminal 100, or jointly by the server 200 and the user terminal 100.

Meanwhile, the user terminal 100 refers to a communication device capable of operating a financial application in a wired or wireless communication environment. The user terminal 100 may be a portable device of the user. In FIG. 1, the user terminal 100 is depicted as a type of portable device, specifically a smartphone, but the present disclosure is not limited thereto and may be applied without restriction to devices capable of operating a financial application as described above. For example, the user terminal 100 may include various types of electronic devices such as personal computers (PCs), laptops, tablets, mobile phones, smartphones, wearable devices (e.g., watch-type devices), and the like.

Additionally, the communication network 300 serves to connect the server 200 with a plurality of user terminals 100a to 100k. Specifically, the communication network 300 refers to a network that provides a connection path allowing the user terminals 100a to 100k to transmit and receive data after connecting to the server 200. The communication network 300 may include, for example, wired networks such as Local Area Networks (LANs), Wide Area Networks (WANs), Metropolitan Area Networks (MANs), and Integrated Service Digital Networks (ISDNs), as well as wireless networks such as wireless LANs, CDMA, Bluetooth, and satellite communication. However, the scope of the present invention is not limited thereto.

Hereinafter, for the convenience of explanation, the performance subject of the personalized federated learning method according to several embodiments of the present disclosure will be described using a specific user terminal 100a as an example.

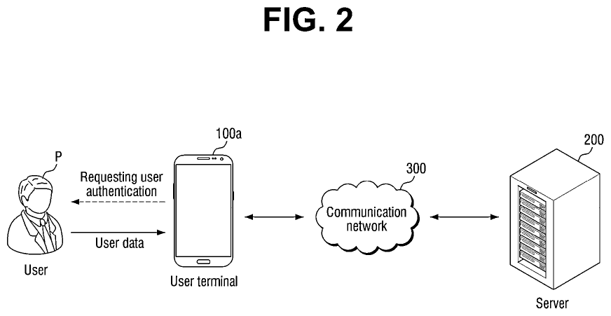

FIG. 2 is a diagram schematically illustrating a user authentication method performed in a personalized federated learning system according to an embodiment of the present disclosure.

Referring to FIG. 2, in an embodiment of the present disclosure, the user terminal 100a may provide financial services offered by the server 200 to a user P. The user P may utilize the financial services provided by the server 200 through the user terminal 100a.

The server 200 may manage multiple user accounts and serve as the entity providing financial services, while the user P may utilize a specific user account among the multiple user accounts to access related financial services. At this time, the user P may be the original owner of the specific user account, or they may be an intruder attempting to use the user account without authorization.

Therefore, the user terminal 100a may request user authentication to verify whether the user P is authorized to use the user account. In other words, the user terminal 100a requests user authentication from the user P and, if the user authentication is successfully performed based on the input data provided by the user, may provide financial services related to the specific user account to the user P.

At this time, the user terminal 100a may display an interface requesting authentication information on the screen and receive input from the user P through input/output devices (not shown) provided in the user terminal 100a. Here, the input/output devices may include at least one of a camera, pad, keyboard, mouse, touchpad, touchscreen, and display device, but the present disclosure is not limited thereto.

The user terminal 100a may generate input data based on the input (i.e., user data) from the user P and perform user authentication based on the generated input data. At this time, the user terminal 100a may be configured to execute the federated learning module in an on-device manner. Here, the federated learning module may be included and executed in the user terminal 100a rather than the server 200.

In other words, the present disclosure may be configured such that the user terminal 100a collects and processes information locally, rather than employing a conventional analysis method in which information collected from the user terminal 100a is transmitted to a central server, such as the server 200 or a separate analysis server, for analysis and then the analyzed results are transmitted back. This approach may enable fast operations through low latency since the information is processed internally within the terminal device. Additionally, it may address security issues, such as the simultaneous leakage or hacking of authentication information from multiple users.

Subsequently, if the user authentication of the user P is successfully performed using the pre-trained federated learning module, the user terminal 100a may transmit the authentication completion result to the server 200. The server 200, in response to the authentication completion result provided by the user terminal 100a, may provide financial services related to the user to the user terminal 100a.

Additionally, in several embodiments of the present disclosure, the user terminal 100a may be configured to allow the federated learning module to perform additional training on the input (i.e., user data) from the newly authorized user P. At this time, the user terminal 100a may collect input data from the user P for user authentication and perform additional training on the federated learning module using the collected input data and authentication results, thereby further enhancing the performance of the federated learning module. Furthermore, after completing the training, the collected user data may be discarded to further improve user privacy protection and security. Here, the input data may be user data or preprocessed user data.

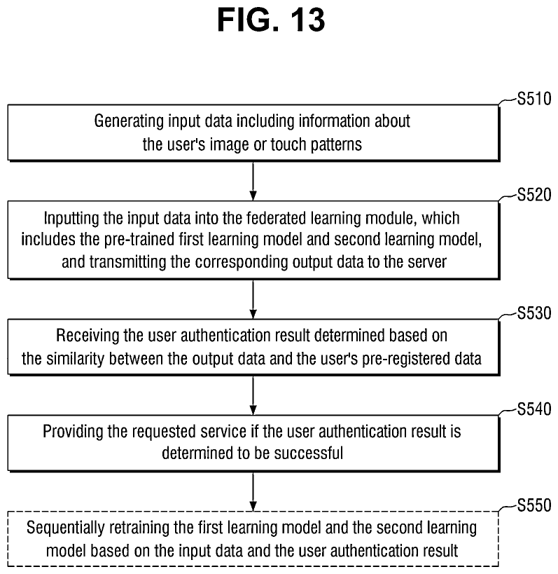

However, the embodiments of the present disclosure are not limited thereto, and in other embodiments, user authentication may be performed by the server 200 based on output data generated by the federated learning module of the user terminal 100a. In this case, the server 200 performs user authentication based on the output data of the federated learning module received from the user terminal 100a. Subsequently, if the user authentication is successfully performed, the server 200 may provide financial services related to the specific user to the user terminal 100a along with the authentication completion result. A detailed description of other embodiments of the present disclosure will be provided later with reference to FIGS. 13 to 15.

Hereinafter, with reference to FIG. 3, a more detailed description will be provided of the configuration of the user terminal 100a that performs the personalized federated learning method according to several embodiments of the present

### DISCLOSURE

FIG. 3 is a block diagram illustrating the components of a user terminal according to several embodiments of the present disclosure.

Referring to FIG. 3, the user terminal 100a includes an interface 110, a database 120, a processor 130, and a memory 140. At this time, the memory 140 loads a preprocessing module PM, a federated learning module FLM, a loss-extract module LM, and a user authentication module UAM, which may be driven (or executed) by the processor 130. Each module may be stored and utilized in the form of a computer program in the database 120 or storage (not shown) included in the user terminal 100a. In addition, in some embodiments of the present disclosure, some of the aforementioned modules may be omitted.

Specifically, the interface 110 generates user data based on the input provided by the user on the user terminal 100a and transmits the generated user data to other components within the user terminal 100a. The interface 110 is included in the user terminal 100a and may be connected to input/output devices for receiving user input. At this time, the input/output devices may include at least one of a camera, pad, keyboard, mouse, touchpad, touchscreen, and display device, but the present disclosure is not limited thereto.

Additionally, the interface 110 performs the function of transmitting and receiving data with the server 200. The interface 110 may include various communication modules and perform data exchange between external devices or the server 200 via the communication network 300.

The database 120 may store data related to the user (i.e., user data), which is received from the interface 110. At this time, the user data may include data entered by the user into the financial application, data for user authentication, and unaware data collected during the user's application usage.

For example, the database 120 may store not only the data entered by the user into the financial application, such as user ID, account holder name, requested financial service details, and transaction passwords, but also data for user authentication, such as facial images captured by the camera of the user terminal 100a, ID card images, biometric information, and security codes. In another example, the database 120 may store sensing data related to touch patterns generated within applications installed on the user terminal 100a, key-stroke data entered by the user, or log data or cookies related to the user's application usage history.

Additionally, user data may include multivariate time-series data. Here, multivariate time-series data refers to time-series data composed of various parameters and arranged in a sequence. For example, user data may include time-series data measured by motion sensors, gyroscope sensors, or similar sensors provided in the user terminal 100a. However, this is merely an example, and the present disclosure is not limited thereto.

Hereinafter, the user data generated in the user terminal 100a and stored in the database 120 will be referred to as local data. Local data may be used to train the first learning model TM1 or the second learning model TM2, which will be described later.

Meanwhile, the processor 130 may execute software to control at least one other component of the user terminal 100a, such as hardware or software components, and perform various data processing and calculations. For example, the processor 130 may load information, commands, or data received from other components, such as the interface 110, into the memory 140, perform calculations using the loaded information, commands, or data, and store the resulting data in the memory 140 or the database 120.

The memory 140 may store and load various data used by at least one component of the user terminal 100a, such as the processor 130. For example, the data may include input or output data related to software and associated commands.

Accordingly, the processor 130 may load and utilize modules or instructions related to various operations of the personalized federated learning method or the user authentication method according to several embodiments of the present disclosure on the memory 140.

First, the processor 130 may use the preprocessing module PM loaded into the memory 140 to perform preprocessing operations on user data received through the interface 110, thereby generating input data.

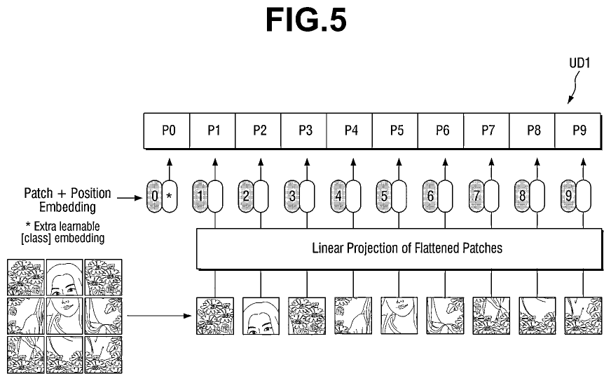

For example, if the user data is an image captured by a camera provided in the user terminal 100a, the processor 130 may use the preprocessing module PM to divide the received image into multiple patches and generate input data by embedding the divided patches based on the positional information of the image. A detailed explanation of this process will be provided later with reference to FIG. 5.

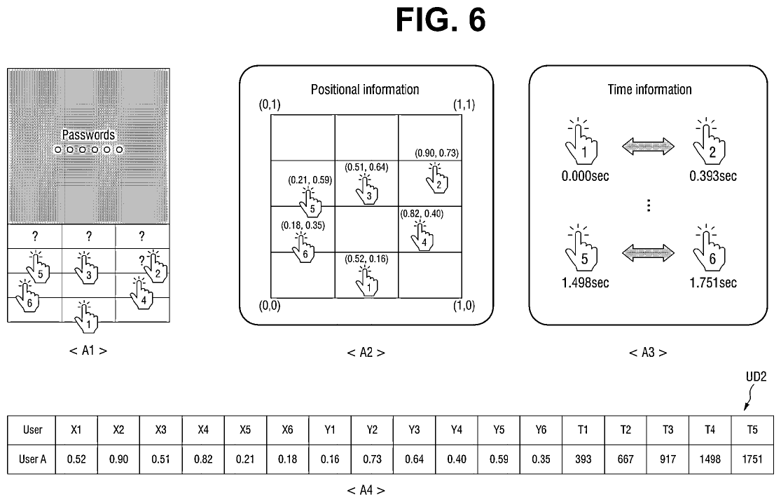

As another example, if the user data includes users touch pattern information applied to a touch display provided in the user terminal 100a, the processor 130 may use the preprocessing module PM to separate the received touch pattern information into positional information (or coordinate information) and time information and generate input data with sequential characteristics. A detailed explanation of this process will be provided later with reference to FIG. 6.

However, depending on the type of user data, the operation of the preprocessing module may be omitted or modified in some embodiments of the present disclosure. Furthermore, the aforementioned descriptions are merely examples of the operation of the preprocessing module PM and are not intended to limit the present disclosure.

Subsequently, the processor 130 may perform user authentication for the user data using the federated learning module FLM loaded in the memory 140. To this end, the processor 130 trains the federated learning module using local data stored in the database 120.

At this time, the federated learning module FLM includes the first learning model TM1 and the second learning model TM2.

Specifically, the first learning model TM1 may receive local data (i.e., input data) as input and generate a corresponding output vector. Here, the first learning model TM1 may include various pre-trained deep learning models and may consist of multiple layers, each comprising a neural network connected through multiple neurons.

Subsequently, the processor 130 may calculate a loss value by comparing the output vector generated by the first learning model TM1 with a reference vector for the local data through the loss-extract module LM loaded in the memory 140. Here, the reference vector may represent the ground truth for the local data (i.e., input data) and may be pre-stored in the database 120.

Subsequently, the processor 130 may train the first learning model TM1 based on the calculated loss value. Specifically, the processor 130 may train the first learning model TM1 by adjusting the weights of the nodes included in the neural network of the first learning model TM1 so that the loss value between the output vector generated by the first learning model TM1 and the reference vector is minimized. At this time, the processor 130 may train the first learning model TM1 to minimize the loss value using a cosine similarity function. Additionally, the processor 130 may train the first learning model TM1 to minimize the loss value using a gradient descent function. However, this is merely an example, and the present invention is not limited thereto.

Subsequently, the processor 130 transmits the weights of the neural network included in the first learning model TM1 trained in the user terminal 100a (i.e., local-global parameters, hereinafter referred to as local parameters) to the server 200 via the interface 110.

At this time, the server 200 calculates global parameters using the local parameters received from multiple user terminals, such as 100a to 100k, and propagates the calculated global parameters back to each user terminal, such as 100a to 100k.

Subsequently, the processor 130 updates the neural network of the first learning model TM1 based on the global parameters received from the server 200 via the interface 110.

The processor 130 then trains the second learning model TM2 using the first learning model TM1, updated with the global parameters, and pre-stored local data. The second learning model TM2 includes multiple personalized parameters, and during the training process of the second learning model TM2, each personalized parameter may be updated. During this process, the processor 130 may utilize the aforementioned loss-extract module LM.

Meanwhile, the user terminal 100a may use the pre-trained first learning model and second learning model, obtained through the aforementioned process, to determine whether there is an anomaly in the new user input data and perform user authentication based on this determination.

Specifically, the processor 130 may determine whether there are anomalies in the newly input user data using the user authentication module UAM loaded in the memory 140. The user authentication module UAM is used in the inference stage of the user authentication method according to several embodiments of the present disclosure. It determines anomalies in input data by comparing the output data derived from the pre-trained first learning model TM1 and second learning model TM2 with pre-registered user data and, based on this determination, decides whether to approve the user authentication.

For example, if the abnormal score, which indicates the similarity between the output data and the pre-registered data, is smaller than the threshold value, the user is determined to be the legitimate owner, and user authentication is approved. Conversely, if the abnormal score is larger than the threshold value, the user is determined to be an unauthorized individual, and user authentication is rejected. However, this is merely an example, and the present invention is not limited thereto.

Meanwhile, as described above, in some embodiments of the present disclosure, portions of the preprocessing module PM and the user authentication module UAM may be omitted in the user terminal 100a or implemented in the server I.

Hereinafter, the operation of the personalized federated learning method according to several embodiments of the present disclosure will be described in detail.

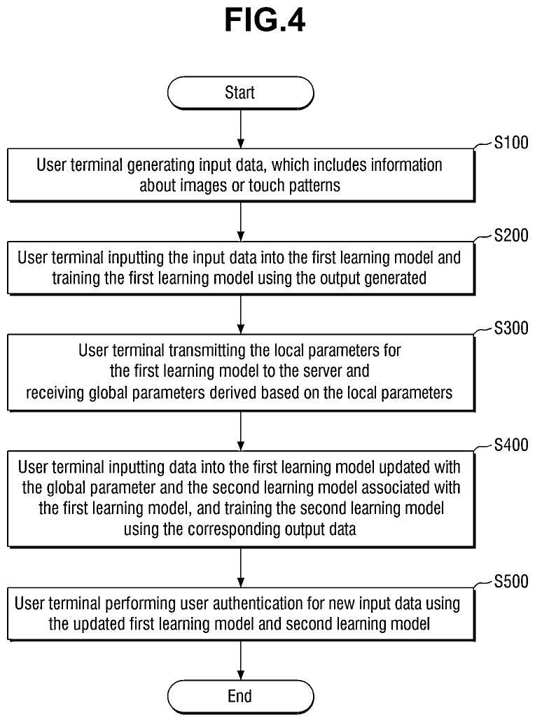

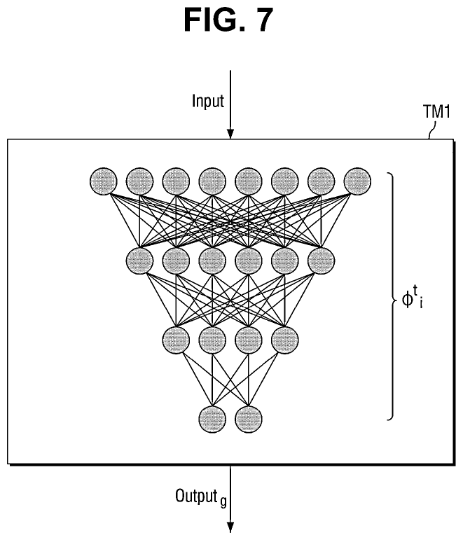

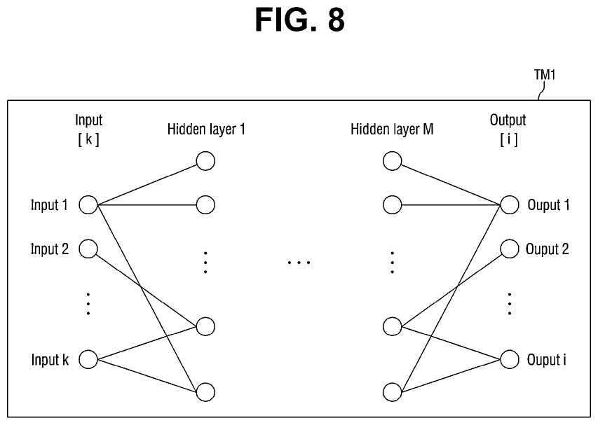

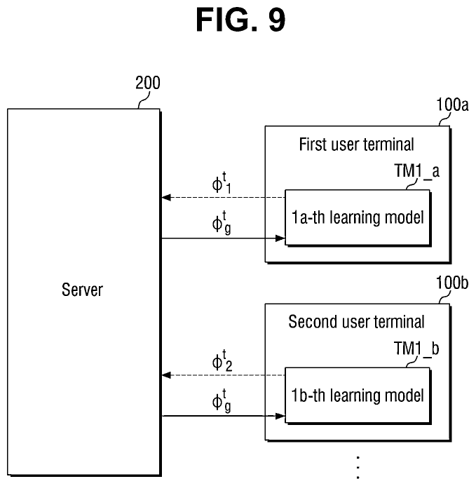

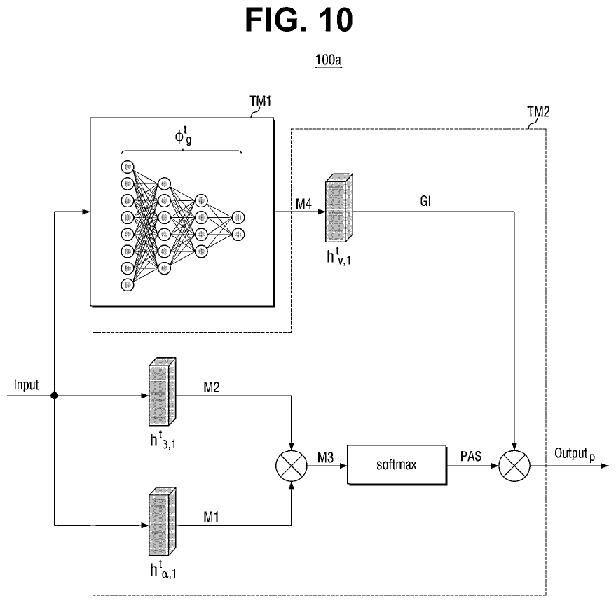

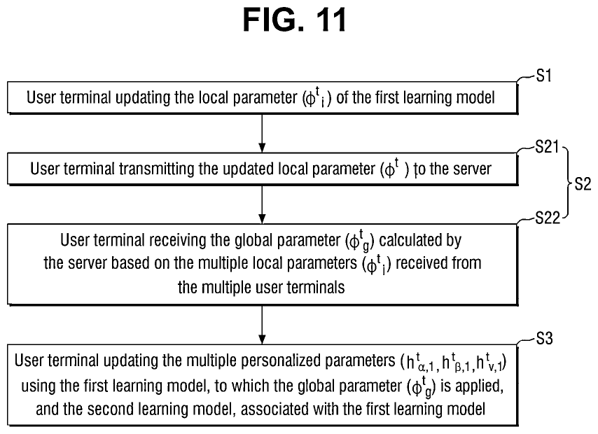

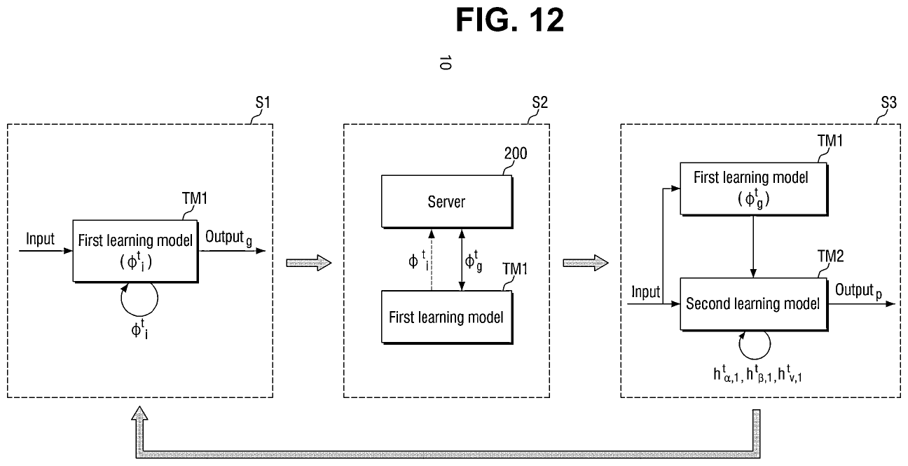

FIG. 4 is a flowchart illustrating the personalized federated learning method according to several embodiments of the present disclosure. FIG. 5 is a diagram illustrating an example of the input data generation process performed in step S100 of FIG. 4. FIG. 6 is a diagram illustrating another example of the input data generation process performed in step S100 of FIG. 4. FIG. 7 is a block diagram illustrating the process of training the first learning model in step S200 of FIG. 4. FIG. 8 is a block diagram schematically illustrating the first learning model of FIG. 7. FIG. 9 is a block diagram illustrating the process of updating global parameters through federated learning in step S300 of FIG. 4. FIG. 10 is a block diagram illustrating the process of training the second learning model in step S400 of FIG. 4. FIG. 11 is a flowchart specifically illustrating the personalized federated learning method according to several embodiments of the present disclosure. FIG. 12 is a block diagram illustrating the personalized federated learning method of FIG. 11.

Hereinafter, for the convenience of explanation, the personalized federated learning method according to several embodiments of the present disclosure will be described using the user terminal 100a or the processor 130 as the example of the performing subject.

Referring to FIG. 4, the user terminal 100a generates input data based on user data, which includes information about images or touch patterns received through the interface 110 (S100). At this time, the user terminal 100a may store the user data entered by the user through the user terminal 100a or the input data generated based on it in the database 120.

The user data received by the user terminal 100a may include various types of input data as described above. However, for the convenience of explanation, the following description will use examples where images captured by a camera provided in the user terminal 100a or user's touch pattern information applied to a touch display of the user terminal 100a are utilized.

Referring to FIG. 5, the user terminal 100a may receive an image of the user through the interface 110. At this time, the received image may be an image of the user's face.

Subsequently, the user terminal 100a may divide the received image into multiple patches. At this time, each patch may be resized to the same dimensions, and each patch may retain positional information about the original image before division. Each patch may also undergo a flattening process.

Subsequently, the user terminal 100a embeds positional information about the original image into the multiple divided patches and linearly combines the patches to convert the image into linear data, thereby generating input data UD1. At this time, as the patches are linearly combined, the input data UD1 takes the form of a sequential vector, and the smaller the size of each patch, the longer the length of the input data. However, this is merely one example of converting an image into input data and the present disclosure is not limited thereto.

Meanwhile, referring to FIG. 6, the user terminal 100a collects information about the user's touch patterns, hereinafter referred to as touch pattern information, through the interface 110 and generates input data.

For example, the user terminal 100a may collect touch pattern information generated as the user enters authentication information, such as a password for user authentication. At this time, personalized input characteristics may be reflected in the user data during the process of the user entering authentication information on the user terminal 100a, and the user terminal 100a may collect these personalized input characteristics as touch pattern information.

Here, the touch pattern information may include information about the location where authentication information is entered on the input interface, such as positional information. In some embodiments, the interface screen displayed on the user terminal 100a may provide input icons for entering authentication information. For example, the input icons may be configured to occupy specific areas on the interface screen, and the areas of the input icons may be defined using X-Y plane coordinates. Here, while the coordinate system used in the present disclosure is not limited to X-Y coordinates, the following description will use the X-Y plane coordinate system as an example for the sake of convenience.

The user may input authentication information by interacting with the input icons, such as by touching or clicking, and the location coordinates (X-Y) of the user's interaction are collected as the positional information of the touch pattern information.

For example, the authentication information may be a password consisting of multiple numbers, and the interface screen may provide the user with multiple number icons corresponding to the numbers 0 to 9, as shown in <A1> of FIG. 6.

At this time, the user may select and sequentially input multiple numbers from the number icons corresponding to the password. On the interface screen, each number icon may be placed in a predefined area, and X-Y plane coordinates may be assigned to each area. The user may interact with the interface screen by touching or clicking the location coordinates of each number icon, and the corresponding number may be entered accordingly.

However, even if multiple users input the same specific number (e.g., the “6” icon) as authentication information, the X-Y plane coordinates where each user interacts (touches or clicks) with the “6” icon may differ. Therefore, such positional information may be utilized as information representing the personalized input characteristics of each user. For example, if the authentication information consists of a six-digit password, the interactions with six numeric icons may result in the collection of six X-Y plane coordinates as positional information, as shown in <A2> of FIG. 6.

Additionally, the touch pattern information may include information related to the time at which authentication information is entered on the interface screen, referred to as time information. The time taken by each user to input authentication information through the interface screen may vary. Therefore, the time information collected by the user terminal 100a may be utilized as information reflecting each user's personalized input characteristics. Here, the time information may represent the time interval required to input the next piece of authentication information; however, the embodiments of the present disclosure are not limited thereto.

Additionally, in some embodiments, authentication information may be configured to relate to multiple input icons on the interface screen. The multiple input icons interact with the user sequentially according to the authentication information, and the interaction time for each icon may be collected. In one embodiment, as shown in <A4> of FIG. 6, the time information may represent the difference between the interaction time of a preceding icon and the interaction time of a succeeding icon. For example, if the authentication information consists of a six-digit password, the X-Y plane coordinates based on interactions with the six number icons may be collected as positional information, and the time differences between the collection times of these plane coordinates may be collected as time information.

In other words, through the aforementioned process, the user terminal 100a may configure the collected touch pattern information as input data. For example, the user terminal 100a may generate input data UD2 corresponding to the user's touch input, as shown in <A4> of FIG. 6, by using the positional information X1, X2, . . . , X6 and Y1, Y2, . . . , Y6, along with the time information T1, T2, . . . , T5, collected during the process of entering a six-digit password. For example, the user terminal 100a may generate input data by mapping positional information and time information for specific touch inputs and organizing them into sequential data arranged in the order of the touch inputs.

However, this is merely an example of generating input data based on user data, and the present disclosure is not limited thereto. The user terminal 100a may store the received user data or input data generated based on it in the database 120 and use the stored local data (alternatively referred to as pre-stored input data) to train the federated learning module FLM.

Subsequently, referring again to FIGS. 4, 7, and 8, the user terminal 100a inputs the received input data or the local data collected in the database 120 into the first learning model TM1 and trains the first learning model TM1 using the output generated (S200).

The first learning model TM1 used in some embodiments of the present disclosure may receive input data generated by the aforementioned method and output data in the form of a vector. At this time, the first learning model TM1 may include a deep learning neural network composed of a multilayer structure.

The database 120 or memory 140 of the user terminal 100a may store input data and result data used for machine learning.

In more detail, deep learning, a type of machine learning, is a method of learning by descending to deep levels through multiple stages based on data.

Deep learning represents a collection of machine learning algorithms that extract essential data from multiple datasets by increasing the depth of processing stages.

The first learning model TM1 may utilize various well-known deep learning structures. For example, the first learning model TM1 may employ structures such as convolutional neural networks (CNN), recurrent neural networks (RNN), deep belief networks (DBN), graph neural networks (GNN), or transformers.

The artificial neural network training of the first learning model TM1 may be achieved by adjusting the weights of the connections between nodes (and, if necessary, by adjusting the bias values) so that the desired output is produced for a given input. The weights in the artificial neural network may be continuously updated through training. At this time, methods such as backpropagation may be used for the artificial neural network training process.

Meanwhile, the memory 140 of the user terminal 100a may be equipped with pre-trained artificial neural networks through machine learning.

The processor 130 may utilize the first learning model TM1 loaded in the memory 140, where the first learning model TM1 may perform embedding operations based on machine learning using local data as input. In this case, both semi-supervised learning and supervised learning methods of machine learning for artificial neural networks may be employed. Additionally, the processor 130 may control the first learning model TM1 such that its artificial neural network structure is automatically updated after training to output a vector closer to the reference vector, depending on the settings.

Referring to FIG. 8, the first learning model TM1 includes an input layer, which takes a specific type of input data as input nodes, an output layer, which outputs the output vector (i.e., output data) as output nodes, and M hidden layers positioned between the input and output layers.

Here, weights may be assigned to the edges connecting the nodes of each layer. These weights or the presence of edges may be added, removed, or updated during the training process. Therefore, through the training process, the weights of the nodes and edges positioned between k input nodes and i output nodes may be updated.

Before the first learning model TM1 performs training, all nodes and edges may be initialized with default values. However, as information is cumulatively input, the weights of the nodes and edges are adjusted, enabling matching between the parameters input as training factors (i.e., input data) and the values assigned to the output nodes (i.e., output data).

Additionally, the weights of the nodes and edges between the input nodes and output nodes of the first learning model TM1 may be updated through the training process of the first learning model TM1 performed within the user terminal 100a by the processor 130.

For example, the processor 130 calculates the loss value by comparing the output vector generated by the first learning model TM1 with the reference vector for the input data. Here, the reference vector may represent the correct answer for the input data and may be pre-stored in the database 120 for use. Subsequently, the processor 130 may train the first learning model TM1 based on the calculated loss value. Specifically, the processor 130 may train the first learning model TM1 by adjusting the weights of the nodes included in the first learning model TM1 so that the loss value between the output vector generated by the first learning model TM1 and the reference vector is minimized. However, this is merely an example of a training method for the first learning model TM1, and the present disclosure is not limited thereto.

Referring again to FIG. 4, the user terminal 100a transmits the local parameters for the weights (local weights) of the neural network included in the first learning model TM1 to the server and, in response, receives global parameters (global weights) through the interface 110 (S300). At this time, the global parameters may be generated by the server 200 based on multiple local parameters received from different multiple user terminals 100a to 100k.

Specifically, referring to FIG. 9, the first user terminal 100a trains the 1a-th learning model TM1_a using local data stored internally and transmits the first local parameter (Ø^{t}₁) of the neural network constituting the 1a-th learning model TM1_a to the server 200. Similarly, the second user terminal 100b trains the 1b-th learning model TM1_b using local data stored internally and transmits the second local parameter (Ø^{t}₂) of the neural network constituting the 1b-th learning model TM1_b to the server 200.

Subsequently, the server 200 derives the global parameter (Ø^{t}_{g}) using the local parameters (Ø^{t}₁, Ø^{t}₂) received from each user terminal 100a and 100b. At this time, the server 200 may derive the global parameter (Ø^{t}_{g}) by calculating the average of the received local parameters (Ø^{t}₁, Ø^{t}₂) or by applying different weights to each local parameter (Ø^{t}₁, Ø^{t}₂).

The server 200 then transmits the derived global parameter (Ø^{t}_{g}) to each user terminal 100a and 100b. Accordingly, each user terminal 100a and 100b, may receive the global parameter (Ø^{t}_{g}) in response to the local parameters (Ø^{t}₁, Ø^{t}₂) it previously transmitted to the server 200.

Subsequently, each user terminal 100a and 100b, may update the first learning models, TM1_a and TM1_b, using the received global parameter (Ø^{t}_{g}). For example, the first user terminal 100a may update the neural network constituting the 1a-th learning model TM1_a using the received global parameter (Ø^{t}_{g}). Similarly, the second user terminal 100b may update the neural network constituting the 1b-th learning model TM1_b using the received global parameter (Ø^{t}_{g}). The process of the user terminals 100a and 100b updating the neural networks of the first learning models, TM1_a and TM1_b, using the received global parameter (Ø^{t}_{g}) may imply that the user terminals apply the received global parameter (Ø^{t}_{g}) to the neural networks of the first learning models TM1_a and TM1_b. Through this, the first learning models updated with the global parameter may be generated.

In other words, the server 200 calculates the global parameter based on the local parameters received from multiple user terminals and performs federated learning by applying this parameter to the first learning model of each user terminal. This allows the improvement of the training performance of the first learning model without sharing data related to personal information generated by the user terminals with other terminals or the server. Through this, the present invention may enhance user privacy protection while also improving the accuracy of user authentication.

Subsequently, referring again to FIGS. 4 and 10, the first user terminal 100a inputs data into the first learning model TM1, updated with the global parameter (Ø^{t}_{g}), and the second learning model TM2, associated with the first learning model TM1. The output data is then used to train the second learning model TM2 (S400). For convenience in explanation, the first user terminal 100a will be referred to as the user terminal 100a.

Here, the first learning model TM1 may refer to the first learning model TM1_a of the user terminal 100a, and the second learning model TM2 includes multiple local-personalized parameters (hereinafter referred to as personalized parameters). At this time, the second learning model TM2 includes the first to third personalized parameters, (h^{t}_{α,i}, h^{t}_{β,i}, h^{t}_{ν,i}). For the sake of convenience, the first to third personalized parameters, (h^{t}_{α,1}, h^{t}_{β,1}, h^{t}_{ν,1}), of a specific user terminal 100a will be used as an example.

First, the processor 130 applies the input data (Input) to the first personalized parameter (h^{t}_{α,1}) and the second personalized parameter (h^{t}_{β,1}) to derive the first intermediate value M1 and the second intermediate value M2, respectively. Additionally, the processor 130 applies the input data (Input) to the first learning model TM1 to which the global parameter (Ø^{t}_{g}) is applied, thereby deriving the third intermediate value M3. This may be expressed as follows in <Equation 1>.

$$M 1 = Input * {h}_{α , 1}^{t} \qquad < Mathematical Expression 1 >$$

$$M 2 = Input * {h}_{β , 1}^{t}$$

$$M 3 = {f}_{g \cdot 1} ( Input , {{∅}^{t}}_{g} )$$

Here, f_{g.1}(Input, Øt_{g}) represents a function that derives the output data (Outputₚ) for the input data (Input) applied to the first learning model TM1 updated with the global parameter (Ø^{t}_{g}). At this time, M1 and M2 may have a matrix data structure, while M3 may have a vector data structure.

Additionally, in other embodiments, the input data (Input) used to derive the first intermediate value M1 and the second intermediate value M2 may consist of preprocessed data generated by the aforementioned preprocessing module PM. For example, when the input data (Input) is an image, the processor 130 may use the preprocessing module PM to divide the received image into multiple patches and generate the input data by embedding the divided patches based on the positional information of the image. At this time, the third intermediate value M3 may be derived using an unprocessed image. However, this is merely an example and the present disclosure is not limited thereto.

Subsequently, the processor 130 applies the third intermediate value M3 to the third personalized parameter (h^{t}_{ν,1}) to derive global information data GI. Additionally, the processor 130 performs a matrix multiplication on the first intermediate value M1 and the second intermediate value M2 to derive the fourth intermediate value M4. Subsequently, the processor 130 derives a personalized alignment score PAS by normalizing the derived fourth intermediate value M4. At this time, the processor 130 may perform normalization on the fourth intermediate value M4 using a softmax function. This may be expressed as shown in <Mathematical Expression 2> below:

$$GI = M 3 * {h}_{v , 1}^{t} \qquad < Mathematical Expression 2 >$$

$$PAS = soft max ( \frac{M 1 * M {2}^{T}}{√ d} ) = soft max ( \frac{M 4}{√ d} )$$

Here, d represents the dimensionality of the matrix multiplication between the first personalized parameter (h^{t}_{α,1}) and the second personalized parameter (h^{t}_{β,1}), and the personalized alignment score PAS may represent the weight indicating the correlation between local data.

Subsequently, the processor 130 performs a matrix multiplication between the personalized alignment score PAS and the global information data GI to generate the output data Outputₚ. This may be expressed as shown in <Mathematical Expression 3> below:

$${Output}_{p} = PAS * GI = ( PAS * M 3 ) * {h}_{v , 1}^{t} = α * {h}_{v , 1}^{t} \qquad < Mathematical Expression 3 >$$

Here, α may represent the local weight for the second learning model TM2.

At this time, the processor 130 may train the second learning model TM2 using the local data stored in the database 120 or memory 140.

Specifically, the processor 130 may calculate a loss value by comparing the output vector from the second learning model TM2 with the reference vector for the local data through the loss computation module LM loaded in the memory 140. Similarly, the reference vector may represent the ground truth for the local data (i.e., input data) and may be pre-stored in the database 120 for use.

Subsequently, the processor 130 may train the second learning model TM2 based on the calculated loss value. Specifically, the processor 130 may train the second learning model TM2 by adjusting the first to third personalized parameters (h^{t}_{α,1}, h^{t}_{β,1}, h^{t}_{ν,1}) included in the second learning model TM2 to reduce the loss value between the output vector from the second learning model TM2 and the reference vector. At this time, the processor 130 may train the second learning model TM2 by utilizing a cosine similarity function to minimize the loss value. Additionally, the processor 130 may train the second learning model TM2 by utilizing a gradient descent function to minimize the loss value. However, this is merely an example and the present disclosure is not limited thereto.

Referring to FIGS. 11 and 12, the personalized federated learning method according to several embodiments of the present disclosure may be summarized as follows: First, the user terminal 100a updates the local parameter (Ø^{t}ᵢ) of the first learning model TM1 based on the user's local data (S1).

Subsequently, the user terminal 100a transmits the updated local parameter (Ø^{t}ᵢ) to the server 200 (S21), and the server 200 calculates the global parameter (Ø^{t}_{g}) based on the multiple local parameters (Ø^{t}ᵢ) received from the multiple user terminals 100a to 100k and transmits it to the user terminal 100a (S22). In other words, the user terminal 100a receives the global parameter (Ø^{t}_{g}), derived through federated learning based on multiple local parameters (Ø^{t}ᵢ), from the server 200 (S2).

In one embodiment, in step S2, the local parameter (Ø^{t}ᵢ) may refer to the multiple local parameters received by the server 200 from multiple user terminals 100a to 100k. For example, if there are k user terminals 100a to 100k (where k is an integer greater than or equal to 2), the first user terminal 100a may transmit the local parameter (Ø^{t}₁), and the k-th user terminal 100k may transmit the local parameter (Ø^{t}ₖ) to the server 200.

Subsequently, the user terminal 100a updates the multiple personalized parameters (h^{t}_{α,i}, h^{t}_{β,i}, h^{t}_{ν,l}) using the first learning model TM1, to which the received global parameter (Ø^{t}_{g}) is applied, and the second learning model TM2, associated with the first learning model TM1 (S3).

At this time, the processor 130 sequentially and repeatedly executes the aforementioned steps S1 to S3. Accordingly, the first timing at which the local parameter (Ø^{t}ᵢ) of the first learning model TM1 is updated in step S1, the second timing at which the global parameter (Ø^{t}_{g}) is updated in the neural network of the first learning model TM1 in step S2, and the third timing at which the multiple personalized parameters (h^{t}_{α,i}, h^{t}_{β,i}, h^{t}_{ν,l}) of the second learning model TM2 are updated in step S3 may differ from each other. In other words, in some embodiments of the present disclosure, the timing at which the local parameter is updated, the timing at which the global parameter is updated, and the timing at which the personalized parameters are updated may differ from each other.

Through this, the personalized federated learning method of the present disclosure may minimize performance degradation caused by data heterogeneity and the loss of local data when using multiple local datasets by separating the timing of updating the global parameter in the first learning model TM1 from the timing of updating the personalized parameters in the second learning model TM2.

Additionally, the present disclosure distinguishes between the first learning model TM1, to which the global parameter is applied, and the second learning model TM2, to which the personalized parameters are applied, and sets different update timings for each. This may prevent performance degradation caused by differences in the distribution of local data.

Subsequently, referring again to FIG. 4, the user terminal 100a may perform user authentication for new input data using the updated first learning model TM1 and second learning model TM2 (S500).

In some embodiments of the present disclosure, user authentication may be performed on the user terminal 100a using the pre-trained federated learning module FLM (see FIG. 2) or on the server 200 based on the data output by the federated learning module FLM of the user terminal 100a (see FIGS. 13 to 15).

Since the embodiment where user authentication is performed on the user terminal 100a has already been described with reference to FIG. 2, the following will provide a detailed explanation of the embodiment where user authentication is performed on the server 200, with reference to FIGS. 13 to 15.

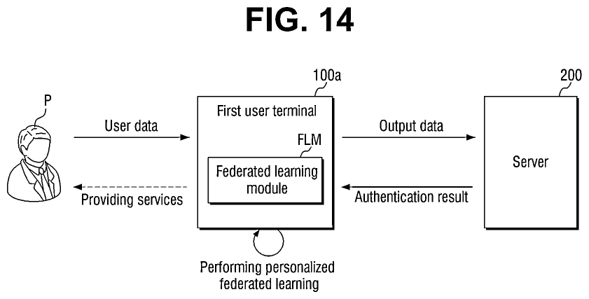

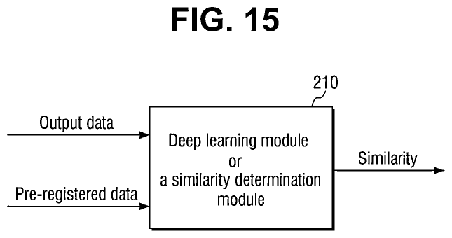

FIG. 13 is a flowchart illustrating a user authentication method performed in a personalized federated learning system according to another embodiment of the present disclosure. FIG. 14 is a block diagram illustrating the user authentication method of FIG. 13. FIG. 15 is a block diagram illustrating the operations of the server described in FIG. 14. The following will focus on the differences, and overlapping content with the preceding description will be omitted.

Referring to FIGS. 13 and 14, the user terminal 100a may generate input data based on newly received inputs (i.e., user data) from the user P and perform user authentication in conjunction with the server 200 based on the generated input data.

Specifically, the user terminal 100a may newly receive information about the user's image or touch patterns through the interface 110 and generate input data for the new input (S510).

Subsequently, the user terminal 100a inputs the generated input data into the federated learning module FLM, which includes the pre-trained first learning model TM1 and second learning model TM2 through the personalized federated learning method described above, and transmits the corresponding output data to the server 200 (S520).

Thereafter, the user terminal 100a receives the user authentication result determined based on the similarity between the output data and the user's pre registered data stored on the server 200 (S530).

Referring to FIG. 15, the server 200 may determine whether user authentication is successful by deriving the similarity between the output data received from the user terminal 100a and the user's pre-registered data stored on the server 200, and comparing the derived similarity with a predefined threshold. Here, the pre registered data is generated based on data previously registered by the user and may be stored and utilized in the database of the server 200.

At this time, the server 200 may calculate the aforementioned similarity using a deep learning module or a similarity determination module 210 (hereinafter referred to as the similarity determination module). Specifically, the similarity determination module 210 may receive the output data from the user terminal 100a and the user's pre-registered data stored in the database of the server 200 as inputs and calculate and output the similarity between the output data and the pre registered data. In this case, the similarity determination module 210 may be implemented as a deep learning module that includes a neural network, similar to the aforementioned first learning model TM1. However, the present disclosure is not limited to this implementation.

Subsequently, the server 200 may determine whether user authentication is successful based on whether the calculated similarity exceeds the predefined threshold. For example, the server 200 may derive an abnormal score representing the similarity between the output data and the pre-registered data. If the abnormal score is smaller than the threshold, the server 200 determines that the user is authentic and approves user authentication. If the abnormal score is greater than the threshold, the server 200 determines that the user is not authentic and denies user authentication.

However, this is merely an example, and the present disclosure is not limited to this.

Subsequently, the server 200 transmits the derived user authentication result to the user terminal 100a. If the received user authentication result is determined to be successful, the user terminal 100a may provide the service requested by the user on the screen of the user terminal 100a (S540).

Additionally, the user terminal 100a may sequentially retrain the first learning model TM1 and the second learning model TM2, included in the federated learning module FLM, based on the input data and the user authentication result (S550). In other words, if the user authentication result is determined to be successful, the user terminal 100a may sequentially retrain the first learning model TM1 and the second learning model TM2 based on the user's input data, the output data of the first learning model TM1, and the output data of the second learning model TM2. However, in some embodiments of the present disclosure, step S550 may be omitted.

In summary, the user authentication method of the present invention enables the local training of the second learning model TM2 on the user terminal by utilizing the first learning model TM1, which applies the global parameters derived from the federated learning process of the server 200. Additionally, it determines abnormalities in the new user input by utilizing both the first learning model TM1, trained through federated learning, and the second learning model TM2, trained locally. Through this approach, the present invention minimizes the burden imposed on the user terminal 100a during the training process of the first learning model (TM1) while improving the accuracy of user authentication.

Additionally, the user authentication method of the present disclosure may enhance the training performance of the federated learning module FLM without sharing local data related to personal information, generated by the user terminal 100a, with other user terminals (e.g., 100b to 100k) or the server 200. This strengthens the protection of the user's personal information while also providing the advantage of improving the accuracy of user authentication.

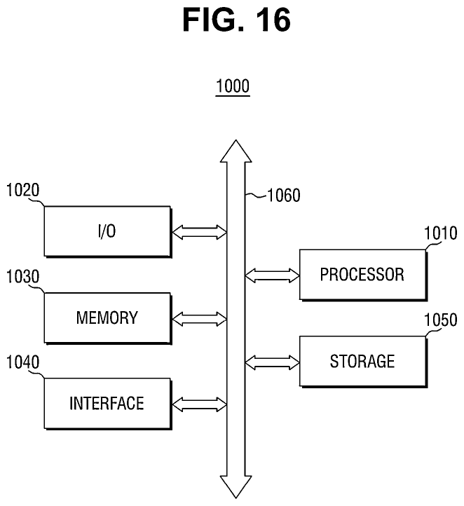

FIG. 16 is a diagram illustrating the hardware implementation of a device or system that performs the personalized federated learning method or the user authentication method according to some embodiments of the present disclosure.

Referring to FIG. 16, the user terminal 100a or server 200 that performs the personalized federated learning method according to some embodiments of the present disclosure may be implemented as an electronic device 1000. The electronic device 1000 may include a processor 1010, input/output device I/O 1020, memory 1030, interface 1040, storage 1050, and bus 1060. The processor 1010, input/output device 1020, memory 1030, interface 1040, and/or storage 1050 may be interconnected via the bus 1060. The bus 1060 corresponds to a pathway through which data is transmitted.

Specifically, the processor 1010 may include at least one of the following logic components: a Central Processing Unit (CPU), Microprocessor Unit (MPU), Microcontroller Unit (MCU), Graphics Processing Unit (GPU), microprocessor, digital signal processor, microcontroller, application processor (AP), or similar functional logic components.

The input/output device 1020 may include at least one of a keypad, keyboard, touchscreen, or display device.

The memory 1030 may load data and/or programs. The memory 1030 may act as an operating memory for enhancing the operation of the processor 1010 and may include high-speed DRAM and/or SRAM. The memory 1030 may include one or more volatile memory devices, such as Double Data Rate Static DRAM (DDR SDRAM) or Single Data Rate SDRAM (SDR SDRAM), and/or one or more non-volatile memory devices, such as Electrically Erasable Programmable ROM (EEPROM) or flash memory.

The interface 1040 may perform the function of transmitting data to or receiving data from a communication network. The interface 1040 may be wired or wireless. For example, the interface 1040 may include an antenna or wired/wireless transceiver.

The storage 1050 may store and retain data and/or programs. The storage 1050 may include one or more non-volatile memory devices, such as a Solid-State Drive (SSD), hard drive, or flash memory. In the present disclosure, the storage 1050 may store computer programs consisting of instructions for performing the personalized federated learning method or the user authentication method.

Alternatively, the server 200 and the user terminal 100a according to embodiments of the present disclosure may each be systems formed by multiple electronic devices 1000 interconnected through a network. In such cases, each module or combination of modules may be implemented as electronic devices 1000. However, this embodiment is not limited to such configurations.

Additionally, the server 200 may be implemented as at least one of a workstation, data center, internet data center (IDC), direct attached storage (DAS) system, storage area network (SAN) system, network attached storage (NAS) system, and redundant array of inexpensive disks or redundant array of independent disks (RAID) system. However, this embodiment is not limited to such configurations.

Furthermore, the server 200 may transmit data through a network using the user terminal 100a. The network may include networks based on wired internet technologies, wireless internet technologies, and short-range communication technologies. Wired internet technologies may include, for example, at least one of a local area network (LAN) and a wide area network (WAN).

Wireless internet technologies may include, for example, at least one of Wireless LAN (WLAN), Digital Living Network Alliance (DLNA), Wireless Broadband (Wibro), World Interoperability for Microwave Access (Wimax), High Speed Downlink Packet Access (HSDPA), High Speed Uplink Packet Access (HSUPA), IEEE 802.16, Long Term Evolution (LTE), Long Term Evolution-Advanced (LTE A), Wireless Mobile Broadband Service (WMBS), and 5G New Radio (NR) technologies. However, this embodiment is not limited to such configurations.

Short-range communication technologies may include, for example, at least one of Bluetooth, Radio Frequency Identification (RFID), Infrared Data Association (IrDA), Ultra-Wideband (UWB), ZigBee, Near Field Communication (NFC), Ultra Sound Communication (USC), Visible Light Communication (VLC), Wi-Fi, Wi-Fi Direct, and 5G New Radio (NR). However, this embodiment is not limited to such configurations.

The server 200, which communicates through a network, may comply with technical standards and standard communication methods for mobile communications. For example, the standard communication methods may include at least one of Global System for Mobile Communication (GSM), Code Division Multi Access (CDMA), Code Division Multi Access 2000 (CDMA2000), Enhanced Voice-Data Optimized or Enhanced Voice-Data Only (EV DO), Wideband CDMA (WCDMA), High Speed Downlink Packet Access (HSDPA), High Speed Uplink Packet Access (HSUPA), Long Term Evolution (LTE), Long Term Evolution-Advanced (LTE-A), and 5G New Radio (NR). However, this embodiment is not limited to such configurations.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims. It is therefore desired that the embodiments be considered in all respects as illustrative and not restrictive, reference being made to the appended claims rather than the foregoing description to indicate the scope of the disclosure.

1. A personalized federated learning method performed by a processor of a user terminal operating in conjunction with a server, the method comprising:
generating input data based on user data received through an interface of the user terminal;
inputting the input data into a first learning model provided in the user terminal and training the first learning model using the corresponding output;
transmitting local parameters for weights of a neural network included in the first learning model to the server;
receiving global parameters derived based on the local parameters from the server; and
inputting the input data into the first learning model, to which the global parameters are applied, and a second learning model associated with the first learning model, and training the second learning model using the corresponding output.

2. The method of claim 1,
wherein the user data includes an image captured by a camera provided in the user terminal or user's touch pattern information input on a touch display provided in the user terminal.

3. The method of claim 2,
wherein the generating the input data comprises:
when the user data is an image captured by the camera provided in the user terminal,
dividing the image into a plurality of patches; and
converting the plurality of divided patches into linear data through embedding based on positional information of the image.

4. The method of claim 2,
wherein the generating the input data comprises:
when the user data is touch pattern information input on the touch display provided in the user terminal,
deriving positional information and time information corresponding to a plurality of touch inputs included in the touch pattern information; and
mapping the positional information and the time information for specific touch inputs and generating sequential data arranged in the order in which the touch inputs are applied.

5. The method of claim 1,
wherein the training the first learning model comprises:
inputting the input data and receiving first output data as an output;
deriving a first loss value of the first output data; and
updating the neural network of the first learning model such that the first loss value is minimized.

6. The method of claim 1,
wherein the global parameter is calculated by the server based on a plurality of local parameters for each of the first learning models provided in different user terminals.

7. The method of claim 1,
wherein the second learning model performs:
(a) applying the input data to a first personalized parameter and a second personalized parameter, respectively, to derive a first intermediate value and a second intermediate value;
(b) applying the input data to the first learning model with the global parameter applied to derive a third intermediate value;
(c) performing matrix multiplication on the first intermediate value and the second intermediate value to derive a fourth intermediate value;
(d) applying the third intermediate value to a third personalized parameter to derive global information data; and
(e) performing matrix multiplication on the personalized alignment score, which is the normalized fourth intermediate value, and the global information data to output second output data.

8. The method of claim 7,
wherein the training the second learning model comprises:
inputting the input data and receiving the second output data generated as the output of the second learning model;
deriving a second loss value of the second output data; and
updating the first to third personalized parameters such that the second loss value is minimized.

9. The method of claim 7,
wherein step (a) comprises:
receiving an image as the input data and dividing the image into a plurality of patches;
converting the plurality of divided patches into linear data through embedding based on positional information of the image; and
multiplying the linear data by the first personalized parameter and the second personalized parameter in a matrix structure, respectively, to derive the first intermediate value and the second intermediate value.

10. The method of claim 7,
wherein the first to third personalized parameters are configured in a matrix form, and
the second output data is configured in a vector form.

11. The method of claim 1,
wherein the training the first learning model and the training the second learning model are sequentially and repeatedly performed.

12. A user authentication method performed by a processor of a user terminal operating in conjunction with a server, the method comprising:
receiving a request for a specific service from a user through the interface of the user terminal;
generating input data based on user data received through the interface;
inputting the input data into the first learning model and the second learning model, which have been pre-trained by the method of claim 1, and transmitting a user authentication result determined based on the similarity between the output data of the second learning model and pre registered user data stored in the server to the server; and
providing the service requested by the user on the screen of the user terminal if the user authentication result is determined to be successful.

13. A user authentication method performed by a processor of a user terminal operating in conjunction with a server, the method comprising:
receiving a request for a specific service from a user through the interface of the user terminal;
generating input data based on user data received through the interface;
inputting the input data into the first learning model and the second learning model, which have been pre-trained by the method of claim 1, and transmitting output data of the second learning model to the server;
receiving a user authentication result from the server, determined based on the similarity between the output data and pre-registered user data stored in the server; and
providing the service requested by the user on the screen of the user terminal if the user authentication result is determined to be successful.

14. The method of claim 13, further comprising:
sequentially training the first learning model and the second learning model based on the input data, first output data of the first learning model, and second output data of the second learning model, if the user authentication result is determined to be successful.

15. An apparatus comprising:
a processor,
a memory configured to load a computer program executed by the processor; and
an interface configured to exchange data with a server during the execution of the computer program,
wherein the computer program comprises:
generating first input data based on user input received through the interface;
inputting the first input data into a first learning model included in the user terminal and training the first learning model using the corresponding output;
transmitting local parameters for weights of the neural network of the first learning model to the server,
receiving global parameters derived based on the local parameters from the server; and
inputting the first input data into the first learning model, to which the global parameters are applied, and a second learning model associated with the first learning model, and training the second learning model using the corresponding output.

16. The apparatus of claim 15,
wherein the computer program further comprises:
receiving a request for a specific service from a user through the interface;
generating second input data based on newly received user data through the interface;
inputting the second input data into the first learning model and the second learning model, and transmitting the output data of the second learning model to the server;
receiving a user authentication result from the server, determined based on the similarity between the output data and pre-registered user data stored in the server; and
providing the service requested by the user on the screen of the user terminal if the user authentication result is determined to be successful.

17. A computer-readable recording medium storing a program capable of executing the method according to claim 1.

18. A computer-readable recording medium storing a program capable of executing the method according to claim 12.

19. A computer-readable recording medium storing a program capable of executing the method according to claim 13.

20. The method of claim 12, further comprising:
sequentially training the first learning model and the second learning model based on the input data, first output data of the first learning model, and second output data of the second learning model, if the user authentication result is determined to be successful.
